(19) United States
(12) Patent Application Publication
(10) Pub. No.: US 2021/0161101 A1
(43) Pub. Date: Jun. 3, 2021

(54) COMBINED HUMAN AND PET WELLNESS FACILITY

(71) Applicant: Lori W. Wyatt, Cary, IL (US)

(72) Inventor: Lori W. Wyatt, Cary, IL (US)

(73) Assignee: The Animal Doctor, Ltd., Cary, IL (US)

(21) Appl. No.: 17/106,953

(22) Filed: Nov. 30, 2020

Related U.S. Application Data
(60) Provisional application No. 62/942,573, filed on Dec. 2, 2019.

(51) Int. Cl. A01K 15/02; A63B 22/02; A63B 22/06

(52) U.S. Cl. CPC A01K 15/027; A63B 2208/14; A63B 22/0664; A63B 22/02

(57) ABSTRACT

A combined human and pet wellness facility includes a wellness facility, at least one human exercise station inside the wellness facility, and at least one pet exercise station together with the human exercise station. The at least one human exercise station and the at least one pet exercise station are configured for simultaneous use.

### CROSS-REFERENCE TO RELATED PATENT APPLICATIONS

This patent application claims the benefit of U.S. Provisional Patent Application No. 62/942,573 filed Dec. 2, 2019, the entire teachings and disclosure of which are incorporated herein by reference thereto.

### FIELD OF THE INVENTION

This invention generally relates to pet and human wellness and more particularly to a combined human and pet wellness facility and method therefore.

### BACKGROUND OF THE INVENTION

In the United States, 72% of men and 63% of women are overweight or obese. So too, 60% of cats and 56% of dogs are overweight or obese. The rate of increase of dog obesity has accelerated eleven-fold from 0.1% increase per year in 2012 through 2014 to 1.1% per year in 2015 and 2016. The medical consequences of obesity in pets include but are not limited to reduced life expectancy, skin disorders, chronic inflammation, kidney dysfunction, diabetes, metabolic and endocrine disorders, orthopedic disease (e.g., arthritis), high blood pressure, cancer and generally diminished quality of life.

Typically, to try to reverse pet obesity and reach optimal pet wellness, pet owners exercise their pets by walking or running their pets, for example, outdoors. The outdoor exercise by the pet and owner may result in maintenance or improvement of the mental and physical wellness of both the pet and owner. Indeed, studies have shown that there are physically mentally beneficial hormone responses, such as the increase in oxytocin secretion by up to several hundred percent, elicited in both the pet and its owner, owners, or custodians (hereinafter, “owner(s)”) when they are together.

While the togetherness may improve pet and owner wellness, owners generally have no medical guidance or supervision with respect to the type of exercise, amount of exercise, type of nutrition, or sleep their pet may need to attain, maintain, or regain the pet's optimal weight and health. Further, the owner's need for or habit of exercise may conflict with the pet's requirement for exercise, resulting in the sacrifice of either the owner's or the pet's exercise.

In many areas where owners live, the climate may present days where various climatic conditions may prevent a healthy walk or run or exercise of both the owner and the pet outside. The climatic condition might include for example, heat, cold, wind, rain, snow and ice. Other factors my prevent both owners and their pets from healthy outdoor exercise, for example, in some communities and cities, parks or sidewalks may not be available or security issues such as ample lighting or policing may not permit the owner and the pet to safely exercise outside. Further, even when owners and pets are not prohibited by climate from outdoor exercise, it is frequently the case that such exercise is characterized by frequent “start-and-stop” periods as dogs, for example, are suddenly distracted by odors and stop walking to sniff. Absent medical monitoring, such unmanaged outdoor exercise and client-pet bonding remains critical for pet well-being. However, sustained intervals of elevated heart and respiratory activity of managed progressive intensity may be inhibited, limiting or preventing optimal health benefits of such exercise.

While owners may find alternative ways for healthy exercise when outdoor exercise is not available, alternative means for medically managed, regular, sustained, and/or progressive intensity exercise by the owner together with the owner's pet are not available. For example, owners may exercise or rehabilitate after an injury or surgery in indoor gyms, pools, or other indoor facilities such as exercise studios or medical rehabilitation facilities. However, heretofore, indoor wellness facilities that permit the owner to exercise together while the pet that is participating in a medically prescribed pet wellness program are simply not available. This can be particularly problematic for pets that have medical conditions with prescribed exercise plans associated with orthopedic rehabilitation that must be supervised or to reverse obesity or to recover, post-trauma or post-surgery.

### BRIEF SUMMARY OF THE INVENTION

Embodiments of the invention provide a combined human and pet wellness center that permits owners to exercise to attend to their own physical well-being while also benefitting from the endocrine and mental well-being that comes from being together with their pet. Typically, the pet will be a dog or a cat. While the owner is exercising, the pet is together with the owner at the combined human and pet wellness center and engaging in a medically supervised prescribed pet exercise program that is part of an overall prescribed pet wellness program with the goal of improving the pet's health. By prescribed it is meant a medical order issued under the authority of a Doctor of Veterinary Medicine (“DVM” or “veterinarian”) or Certified Canine Rehabilitation Practitioner (“CCRP”) for a drug, diagnostic test, device, or treatment for the pet. Such treatment may include but is not limited to physical therapy and or exercise such as exercise that is supervised by a veterinary professional who performs under the authority of a DVM.

More specifically, embodiments of the invention provide that an owner may have their pet medically evaluated by a DVM. The DVM evaluation, also referred to as a veterinarian evaluation, may be needed because of a medical condition experienced by a pet such as obesity or muscular atrophy, or because of post-surgical rehabilitation required for recovery from trauma incurred by the pet, for example, a broken leg or a cruciate ligament rupture. Alternatively, the DVM evaluation may be a routine physical examination of the pet to catch any possible medical conditions that could be present in the pet, for example skin disorders, chronic inflammation, kidney dysfunction, diabetes, metabolic and endocrine disorders, orthopedic disease (e.g., arthritis), high blood pressure, heart disease, neurological disorders, or cancer. Such medical conditions can shorten the duration and reduce the quality of the pet's life. The DVM may conduct a clinical exam and may evaluate any diagnostic testing results that may have been ordered, for example, x-rays, ultrasound, Computer Tomography, blood work, urine analysis, exploratory operative findings, etc. and prescribe a medical pet wellness program that may include a prescribed pet exercise plan that may also be a prescribed pet rehabilitation plan.

The veterinarian may record the pet's symptoms (if any) as relayed by the pet owner. Objective clinical exam findings, diagnostic records and findings therefrom, differential or definitive diagnoses, and prescribed medications or therapy/rehabilitation data in the pet's medical record may also inform the DVM and other veterinary medical staff of the pet's health status. For example, the pet may be diagnosed as obese. The veterinarian may prescribe a pet wellness program for the pet that includes a prescribed pet exercise plan and or a prescribed pet nutritional diet plan that becomes part of the pet's medical record.

The medical record may be a digital record stored in the veterinarian's server based on a unique identifier for the pet. The server may be a secure server on or off site from the DVM's medical facility. For example, the secure server may be on site at the combined human and pet wellness facility or off site in a private and or public cloud, or at a veterinarian's office or other third party location relative to the combined human and pet wellness facility that herein is considered as on site. The server may be part of a facility network and may be in communication via an on-site local area network (LAN) that is part of the facility network. The server LAN physical layer communication may be wired or wireless and that is, in turn, in communication with the internet via wide area network (WAN) physical layer connectivity, so that the DVM, the owner, or other permitted users may access and view the medical record via any mobile device or computer with access to the internet by which access to the on site and or off site veterinarian server and pet medical record may be securely enabled.

The pet at the clinical visit with the veterinarian may present with a biosensor carried by the pet where such biosensors may be, for example, subcutaneously embedded pet microchips as described, for example, at https://www.avma.org/microchipping-animals-faq last retrieved Nov. 25, 2020, the entire teachings of which are incorporated herein by reference thereto. The biosensors may be attached to pet clothing, attached to or strapped to the pet via collars as described for example at https://petpace.com/smart-sensing-collar/, last retrieved Nov. 25, 2020, the entire teachings of which are incorporated herein by reference thereto. The biosensor may also be in a pet harness as described for example at https://getrawr.com, last retrieved Nov. 25, 2020, the entire teachings of which are incorporated herein by reference thereto.

Biosensors may be used that leverage radio frequency near-field communication (RF NFC) technology such as described, for example, at https://www.vivokey.com, last retrieved Nov. 25, 2020, the entire teachings of which are incorporated herein by reference thereto. Biosensors may also be used that are part of an embedded and or wearable sensor ecosystem as described, for example by Maria Lineden and Mats Bjorkman, “Embedded sensor systems for health, providing the tools in future healthcare” and Richard Bloss, “Embedded medical sensors, an emerging technology to monitor hearts, brains, nerves, and addressing other medical applications for improved patient care,” the entire teachings of both articles are incorporated herein by reference thereto. Such biosensors may work together with devices such as smart watch products, for example those by Apple®.

The biosensors may utilize energy harvesting products that provide alternatives to battery power for pet-wearable and pet-embedded sensors such as those described, for example, at https://www.powerfilmsolar.com/products/development-kits/?utm_source=google&utm_medium=cpc&utm_campaign=internet-of-things&utm_content=development-kits-a&gclid=CjwKCAiA7939BRBMEiwA-hX5J-IihffBsMaapQ76y7zyMsWJmFnyi55dKTcvXKMhCbi1K2XKW2WFThoChh4QAvD_Bw E., last retrieved Nov. 25, 2020, the entire teaching of which are incorporated herein by reference thereto.

The biosensors may also utilize energy harvesting technologies as described for example in U.S. patent application publication no. 2014/0060603 to Kriisa et al. and in the article, “Energy Harvesting Wireless Sensors for Helicopter Damage Tracking” by Steven W. Arms et. al, the entire teachings of which are incorporated herein by reference thereto. The biosensors coupled with RF NFC connectivity may work with, that is exchange data with smart watches as described, for example, at https://www.apple.com/healthcare/apple-watch/, last retrieved Nov. 25, 2020, the entire teachings of which are incorporated herein by reference thereto. The smart watches are wearable device platforms hosting a variety of existing and emerging sensors such as but not limited to those biosensors referenced herein. The smart watches along with smart phones may enable communication between the biosensors which may be used in or may be adaptable for pet use and LAN and or WAN networks by which communication may be enabled between the biosensors and specific pet medical records stored on wellness center servers.

The biosensor senses and stores and or transmits sensed biophysical parameters from the pet to addressable owner and or wellness center smart watches, smart phones, tablets, computers, LAN Wi-Fi network access portals or other fixed and/or mobile devices that can be used to directly or indirectly communicate pet biophysical parameters to wellness center veterinary staff and or to wellness center servers. Biosensors for oxytocin are described at: https://www.ist-ag.com/en-us/products-services/biosensors?gclid=CjwKCAiA7939BRBMEiwA-hX5Jy7CXiu-DjVQ87VW2bQOSeG1J9aPpE4Ozde_5eLgFyIxRNKgfKja3xoCWqgQAvD_BwE, last retrieved Nov. 25, 2020; “Development of a Genetically-Encoded Oxytocin Sensor” by Neymi Mignocchi et al.; which selectively recognizes even small amounts of oxytocin; “Synthetic infrared nanosensors for real-time monitoring of oxytocin release,” by Markita Landry, of the University of California Berkeley, and “Continuous and selective measurement of oxytocin and vasopressin using boron-doped diamond electrodes,” by Kai Asai et al., the entire teachings of all the foregoing are incorporated herein by reference thereto and therefore will not be more fully described herein.

By carried it is meant that the biosensor may already have been in place on the pet, for example it may be carried on the pet's collar or may have already been embedded in the pet. Alternatively, the veterinarian may place a biosensor on or embed the biosensor in the pet. In another example, carried may mean that a biosensor is fixed at, attached to or embedded in a pet exercise station or piece of pet exercise equipment such as, for example, a pet dry treadmill, pet swimming pool, or pet underwater treadmill. Also, for example, carried may mean that a biosensor is attached on or otherwise embedded in a harness, strap, collar, pet garment, pet clothing, pet footwear or other means of connecting the biosensor to the pet such that such that the biosensor may be worn by a pet during its exercise at the pet exercise station.

The biosensors record biophysical parameters of the pet, for example, the pet's activity or energy exertion level, heart rate, glucose level, biochemistry, or respiration rate which in turn can be used to determine the pet's rest and/or sleep pattern. Such parameters may be measured in real time and transmitted via wireless (for example, RF NFC) or wired (for example, via copper, cable or optical fiber) communication for pet medical record storage and or analytical processing. Biosensors may also include electronic storage or memory capacity, enabling capture and retention of biosensor measurement data for a given period of time and then retrieved from the biosensor for later use. For example, the biosensor may store a day's worth of sensed biophysical parameters that may be transmitted automatically and or periodically to owner communication devices, for example, smart phones or computers. Such transmission may be managed through a wellness center application that securely manages identification, retrieval, recording and transmission of biophysical parameters from biosensors to pet medical record repositories on wellness facility servers. The sensed biophysical parameters may be taken into consideration by the veterinarian in reaching a diagnosis and prescribing a pet wellness exercise program to address the diagnosed condition.

As a result of the pet's veterinary examination at the clinical visit, the pet may be diagnosed with one or more physical conditions such as, for example, obesity, excess weight, skin disorders, chronic inflammation, kidney dysfunction, diabetes, metabolic and endocrine disorders, orthopedic disease (e.g., arthritis), high blood pressure, heart disease, neurological disorders, or cancer. To treat the pet's diagnosed condition, the veterinarian may prescribe a pet wellness program that includes a prescribed pet exercise plan that includes pet exercise together with the owner and a prescribed pet nutrition plan. The prescribed pet exercise plan may include pet exercises such as timed walks or runs with or without prescribed degrees of inclines or decline for increased and or differentiated hind leg and foreleg muscular stimulation, aerobic stimulation, or joint stabilization for example.

A mix of high intensity, short duration or low intensity, longer duration exercise may be prescribed. These walks and or runs may be prescribed to occur, for example, on dry treadmills or underwater treadmills which enable LAN communication between the treadmill and pet medical records. Prescribed exercise may include swimming against programmable and variable swim current strengths and durations enabled, for example, by dual swim current configurations by which pets and veterinary staff or pets and pet owners may swim together, with each swimmer swimming against a dedicated, programmed swim current providing periodic and or variable swim resistance designed to achieve measurable health objectives.

The prescribed pet exercise plan may have set periods of rest and activity and may require aerobic or anaerobic exercise which may also be accomplished via the pet wellness center exercise devices such as on a dry pet treadmill, an underwater treadmill, a pool or strength-building equipment. Moreover, such prescribed pet exercise plans may require monitoring and supervision by a trained veterinary professional such as the veterinarian, a veterinary technician, or veterinary assistant trained in managing the performance of the pet during prescribed pet exercise as well as the monitoring and recording of the results of the pet's exercise. The veterinary professionals may also be trained in obtaining measurements of certain pet biophysical parameters before, during and after the pet's exercise or therapy.

Embodiments of the invention provide for a combined human and pet wellness center that permits the owner and pet to be together while the owner and the pet engage in physical exercise together. The combined human and pet wellness center may be dimensioned to accommodate any desired number of owners, their pets, and employees.

Other embodiments of the invention provide a combined human and pet wellness center that permits the owner and pet to be together while the pet participates in the prescribed pet exercise plan that is part of the overall prescribed pet wellness program. The prescribed pet exercise program takes place in the combined human and pet wellness center so that the prescribed pet exercise plan may be carried out, monitored, supervised, measured, and/or recorded by a trained veterinary professional. The combined human and pet wellness center may be dimensioned to accommodate any desired number of owners, their pets, employees and veterinary professionals.

The term “together,” has a specific definition with respect to the invention. In an embodiment of the invention, “together” may mean the pet owner and the pet enter and leave the combined human and pet wellness center together but are not in direct view of one another while the pet is engaged in the prescribed pet exercise program. For example, the pet may be on a pet treadmill and the owner may exercise on a human treadmill but the owner and the pet may or may not be able to see one another while exercising. In an example of this “togetherness” the owner may be visible to the pet on an electronic display/screen that may present a real time view of the owner or a recorded view of the owner. However, in another example, the owner need not be present to the pet on an electronic display, it is sufficient that they are in the wellness facility together even though they cannot see one another while actually they are engaged in an exercise. Consistent with best practices for animal hospital or animal clinic visits, the owner and pet arrive at and depart from the facility together, but there may be examination, treatment or surgery events where the owner and pet are not in the same room. It is enough that the pet and owner enter the combined human and pet wellness center together as the pet enjoys the increase in beneficial hormones such as oxytocin, for example, produced in this scenario.

In another embodiment, “together” may mean near to one another such that the owner is visible to the pet while the pet is engaged in exercise or in the prescribed pet exercise program. In another embodiment, “together” means the owner and the pet are next to one another in that they are within 20 feet of one another while the owner exercises and the pet engages in exercise or the prescribed pet exercise plan. In other words, the exercise devices that the owner and the pet are using may be physically located near to one another, for example, in a side by side or end to end relation such that the owner is visible to the pet while the pet is using a pet exercise device.

In an embodiment, the combined human and pet wellness facility is a wellness facility that is a brick and mortar wellness facility specifically designed to permit an owner and the owner's pet to exercise together.

In another embodiment the brick and mortar facility is arranged for the practice of veterinary medicine including pet rehabilitation including pet exercise under the supervision of a veterinary professional. However, unlike typical veterinary medicine hospitals and rehabilitation centers, the wellness facility is unique in that it is designed to accommodate and extend the togetherness of the pet and the owner to facilitate and encourage physical exercise by the owner while the pet engages in its prescribed pet exercise plan under professional supervision.

In an embodiment of the combined human and pet wellness facility, the at least one human exercise station and the at least one pet exercise stating are configured for simultaneous use. By configured for simultaneous use it is meant that the at least one human exercise station and the at least one pet exercise station are together and are available to be used at the same time.

In an embodiment of the combined human and pet wellness facility, the at least one human exercise station and the at least one pet exercise stating are configured for simultaneous use. By configured for simultaneous use it is meant that the at least one human exercise station and the at least one pet exercise station are together and are available to be used for exercise at the same time.

In another embodiment, by configured for simultaneous use it is meant that the at least one human exercise station and the at least one pet exercise station are together and are available to be used for exercise at the same time by an owner and a pet. It is well established in the literature that positive human-pet interaction increases the favorable increase in beneficial oxytocin response in both the human and the pet. A combined human and pet wellness facility experience that promotes such human-pet interaction through the establishment of enhanced social networking among multiple owners-pets social units through a shared exercise facility has been heretofore been unknown for owners and their pets.

In an embodiment, upon entering the wellness facility together, the pet and the owner may check in with an employee who may or may not be a trained veterinary professional or at a kiosk and begin their exercise together.

In other embodiment, upon entering the wellness facility together, the pet and the owner present to one of the trained veterinary professionals. The veterinary professional may access the pet's unique identifier from a pet biosensor on or embedded in the pet or may obtain the unique pet identifier from the owner. The pet identifier information may include but is not limited to the pet's name, address or owners name or a combination thereof. The trained veterinary professional may then retrieve the pet's digital medical record from the wellness center or wellness facility server, or server connected via Wi-Fi or Ethernet, for example, to the wellness center network that may be a local area network. The prescribed wellness program for the pet may be reviewed by the veterinary professional.

Next, the veterinary professional may record in the pet's digital medical record any relevant comments from the owner regarding the pet's well-being, for example, how the pet has been eating, sleeping, its comportment, urination, skin, etc. The veterinary professional may also upload sensed biosensor data that has been recorded in the biosensor or biosensors of the pet or may record the real time readings from the biosensor or biosensors in the pet's digital medical record. The veterinary professional may review stored biosensor data as collected by the owner between visits. Such collection may be from a mobile device that has stored the biosensor data. Based on a prescribed pet exercise plan, pet medical history and pet biophysical data derived from prior pet wellness center exercise, subsequent session wellness center exercise equipment settings may be automatically or manually downloaded to the pet exercise equipment, to the owner's mobile device or to veterinary staff devices to ensure that pet exercise session activity is managed in conformance with prescribed exercise medical and or health objectives.

In an embodiment, the owner and the pet may present to a social networking area for medical socialization, psychological accommodation, and progressive client-pet exercise habit conditioning. This enhances “togetherness” in a medically supervised environment, provides pet-owner shared wellness acculturation, enables veterinary professional(s) observation and treatment—including medically appropriate diet administration—to optimize, for example, pre exercise muscle stimulation, permit further measurement of pre-exercise oxytocin measurements to support exercise prescription optimization, etc. The social area network may be part of, hence in communication with the facility network such that the sensed biosensor physical parameters may be observed and recorded while the pet is in the social networking area.

The pet is then brought to the pet exercise station to start the prescribed pet exercise. In an example, the pet exercise station includes a pet exercise device. The pet exercise device may include an interactive electronic display and may be a smart device that is able to communicate via the facility network that may be, for example a pet wellness center Wi-Fi LAN, a pet wellness center enterprise cellular network and or Ethernet network with a pet wellness center server, servers or Storage Area Network to retrieve the pet's digital medical record and prescribed pet exercise plan.

At the pet exercise device, the veterinary professional may also be able to retrieve the pet's digital medical record and the prescribed exercise plan and then set, either manually or automatically from the pet record download, the pet exercise device operating controls and parameters as indicated in the pet's prescribed exercise plan. For example, the pet may start the prescribed exercise plan in the endless pool or underwater treadmill or dry pet treadmill. The veterinary professional may harness the pet for safety in the endless pool or underwater treadmill or dry pet treadmill. The harness may or may not have biosensors that communicate, via RF NFC to owner and or pet wellness center networked wired or wireless communication devices, real time sensed biophysical parameters of the pet during a pet exercise session. In an example, the pet exercise station may be an open area that is a pet agility area where the pet may or may not be harnessed or leashed to facilitate the exercise or collection of sensed biophysical parameters of the pet.

In an example where the pet exercise station includes a pet exercise device, device performance settings such as treadmill speed or swim current velocity and exercise duration time may be manually or automatically set so as to effectuate the prescribed pet exercise program. For example, with the endless pool swim current acceleration, fixed swim current velocity, and swim current deceleration sequence or sequence repetition may be set to control pet exertion. So too, a dry treadmill or underwater treadmill belt acceleration, fixed belt velocity, and belt deceleration sequence repetition, along with treadmill inclination or declination may be set. Duration of treadmill time and or frequency or pattern of setting changes may also be set. The physical active operation settings of pet exercise devices may be established manually by the owner or the veterinary professional or such settings may be established automatically for the pet exercise device based upon the digital information or commands transmitted to pet exercise devices from the pet's digital medical record, with such settings being retrieved from the server via the local area network or LAN that may comprise a wireless, wired or hybrid optical fiber-wired-wireless network all of which may be part of the facility network.

So too, the physical settings of components of the pet exercise devices may be done automatically based upon information received via sensed biophysical parameters received from one or more pet biosensors in real time, for example, or from electronically stored biosensor data in the wellness center server, servers or Storage Area Network. The local area network may be wired via copper or fiber connectivity or wireless and in communication with an on-site secure server, servers or pet wellness center Storage Area Network, or may be connected to the internet to retrieve information from an off-site, secure pet wellness center server, servers or Storage Area Network.

Real time sensed biophysical parameters of the pet while it is exercising may be retrieved for example by one or more biosensors embedded in or on the pet or on the pet's collar or from a biosensor on the harness that may be physically connected to the pet exercise device or wirelessly connected to the pet exercise device. The veterinary professional may continuously or periodically monitor the pet and monitor the real time sensed biophysical parameters of the pet during the prescribed pet exercise plan to ensure pet safety and to carry out the prescribed pet exercise plan. The veterinary professional may save the sensed results in the pet's digital medical record manually or such sensed results may be automatically saved into the pet record during or after a pet exercise session.

In an embodiment, while the pet is exercising the owner may be together with the pet in the same wellness facility exercising but may not be visible to the pet. This togetherness is common in owner-pet veterinary facility visits where the owner and the pet may become physically separated as when, for example, the pet is under anesthesia during surgery prior to subsequent, post-recovery physical client-pet re-union.

In an embodiment, the pet and the owner are together in the same wellness facility and the owner may be visible to the pet while the pet exercises via an electronic display or monitor, for example a TV or tablet computer that enables audio-visual communication between the pet and the owner in real time, for example, exercising in another part of the facility at a human exercise station, but as discussed earlier, such an audio-visual monitor or electronic display need not be present for the pet and owner to experience the benefit of togetherness as entering the wellness facility together, may suffice. This togetherness is common in owner-pet veterinary facility visits where the owner and the pet may become physically separated as when, for example, the pet is under anesthesia during surgery prior to subsequent, post-recovery physical client-pet re-union.

In an embodiment, the human exercise station may include a human exercise device that may be present in the wellness facility. Examples of human exercise devices may include, by way of not limiting examples, one or more dry treadmills, recumbent bikes, speed bikes, elliptical machines, weight machines, resistance machines, stair steppers, rowing machines, etc. In another example the human exercise station may be a designed space such as a pool or track. In other examples, the human exercise station may be an open space for exercise such as an open space with weight resistance, medicine balls, Pilates stations, or exercise mats for jumping rope, stretching, calisthenics, yoga and meditation.

In another embodiment, while the pet exercise station may be near the human exercise station such that the pet is able to see the owner exercising, this may be possible in embodiments where the pet is on a pet exercise device or in an open area and the owner is exercising on a human exercise device or open area where the owner may be stretching for example or engaging in weight resistance training.

In another embodiment the pet may be exercising at a pet exercise station and the owner may be exercising at a human exercise station that is next to the pet. As discussed above, by “next to” it is meant that the owner and the pet are within 20 feet of one another and the pet exercise device and the human exercise device are touching or within 20 feet of one another. For example, where the pet exercise station includes a pet exercise device such as a dry pet treadmill and the human exercise station includes a human exercise device, for example a human treadmill, the pet exercise device and the human exercise device may be next to each other such that they are in a side by side or end to end relation ensuring that the owner is visible to the pet while the pet is using a pet exercise device. As discussed above the visibility of the owner to the pet produces advantageous mental and physical wellness for the pet.

During or after the pet has finished the prescribed pet exercise plan the results are recorded in the pet's digital medical file. Such results may include for example the level of resistance of the pet exercise device or the duration of the activity, or biophysical parameters sensed during or after the exercise. The veterinary specialist may also record any observations, or comments or suggestions for further care.

After exercise, in an embodiment, the pet owner of the pet may present again or for the first time to the social networking area for post exercise physical and nutritional recovery and progressive client-pet exercise habit conditioning. This enhances “togetherness” in a medically supervised environment, provides pet-owner shared wellness acculturation, enables the veterinary professional(s) observation and treatment—including medically appropriate diet administration to optimize, for example, post-exercise muscle recovery, to permit further measurement of post-exercise oxytocin measurements and to support exercise prescription optimization, etc. Sensed biosensor physical parameters may be observed and recorded in the social networking area.

The veterinarian may modify the prescribed pet wellness program and prescribed pet exercise plan and or the prescribed pet nutritional plan based on pet recovery from an injury or surgery, or when the pet is no longer diagnosed as overweight or obese. The veterinarian may then prescribe a pet wellness center maintenance program whereby pet wellness bio-monitoring as aided by the combination of continued owner-pet co-exercise and pet biosensor data collection and analysis may be used in a fashion to continuously optimize pet health and pet quality of life as the pet ages.

In an embodiment, the pet's digital medical record may be updated at any time with real time, continuously sensed pet biophysical parameters that are measured with the aid of biosensors, for example via the RF NFC connectivity between biosensors and owner smart watch, smart phone or computer devices that are networked, in turn, with owner home LAN Wi-Fi or WAN internet connections to pet wellness center server or cloud facilities. Alternatively, via a pet wellness center application for example, pet wellness center voice, video or digital input from the owner of owner-observed behavior of the pet, such as when the pet sleeps or participates in general physical activities, may be uploaded to the pet's wellness center medical records. Delivery of such biosensor-measured biophysical data, aided by pet wellness center application installation on owner smart watch, smart phone and computer devices may be either manually or automatically transmitted to the pet's medical record. Transmitted information may include, for example, the quantity and type and timing of pet activities and nutrition, rest periods and rest quality, or periodic measurements of weight, lean versus fat body mass composition and other biophysical parametric data sensed by pet biosensors.

While a prescribed pet wellness program may result in the achievement of targeted pet health and or medical objectives, the veterinarian may still suggest to the owner a long-term pet wellness health maintenance plan that is continuously adjusted to address pet geriatric wellness progression. Prescribed, periodic pet exercise together with the owner at the wellness facility, along with a prescribed nutritional plan, and periodic preventative veterinary examinations along with continuously available pet biosensor biophysical data may be integrated to ensure optimal pet wellness.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic view of an embodiment of a combined pet and human wellness facility;

FIG. 2 is a partial perspective view of another embodiment of a combined pet and human wellness facility;

FIG. 3 is another partial perspective view of the combined pet and human wellness facility;

FIG. 4 is a diagram of an example of a method for using a combined pet and human and wellness facility; and

FIG. 5A and its continuation in FIG. 5B diagram another embodiment of a method for using a combined pet and human wellness facility.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

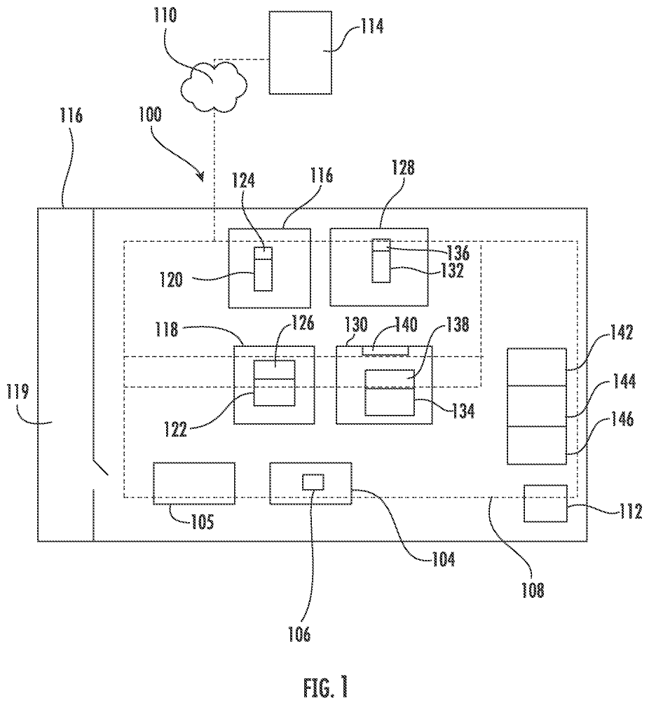

Turning now to the drawings, there is illustrated in FIG. 1 an exemplary schematic drawing of an embodiment of a combined human and pet wellness facility 100 (hereinafter, wellness facility). While such an exemplary embodiment will be utilized in describing various features and advantages of examples of the invention, such a description should be taken by way of example and not by limitation.

The wellness facility 100 may be a brick and mortar construction where pet owners are able to exercise together with their pets. As previously discussed, the pet exercise may be a prescribed pet exercise program that is part of an overall prescribed pet wellness plan established after a veterinary physical examination.

The wellness facility 100 includes a reception area 104 that may include a reception registration kiosk. The reception area 104 may include a computing device 106 that is connected via wired, wireless or optical physical layer interconnect to a facility network 108 that may be a local area network 108 that may communicate with a wide area network 110 such that it can retrieve and store information in at least one on-site secure server 112 or at least one off-site secure server 114. Processing of the information may occur either at the computing device 106 or at the on-site secure server 112 or off-site secure server 114. Non limiting examples of the computing device may include a personal computer, lap top computer, tablet, or a mobile device such as a smart phone.

The wellness facility 100 may also include at least one human exercise station 116, 118 inside the wellness facility. The wellness facility 100 may have any number human exercise stations 116, 118 depending on the size and exercise user capacity of the wellness facility 100. The human exercise station 116, 118 may be in an open space where the owner may exercise or it may be a designed space 119 such as indoor running track or pool. In other examples, the human exercise station 116,118 may have a human exercise device 120, 122 with an interactive programmable controller 124, 126 with display that is connected to the local area network 108 and/or to the wide area network 110. Examples of human exercise devices 120, 122 may include by way of non-limiting examples, a dry treadmill, a recumbent bike, a speed bike, an elliptical machine, a weight machine, a resistance machine, a stair stepper, and a rowing machine, etc.

The wellness facility 100 may also include at least one pet exercise station 128, 130 together with the human exercise station 116, 118. The pet exercise station 128, 130 may have a pet exercise device 132, 134 such as a dry pet treadmill or an underwater pet treadmill, or an endless pool, etc. Alternatively, the pet exercise station 128, 130 may be an open area where pet exercise may take place such as agility training. The pet exercise device 132, 134 may include an interactive programmable controller 136, 138 with display that is connected to the local area network 108 and/or the wide area network 110. The pet exercise station 128, 130 may also include an electronic display 140 such as a smart TV that may be part of the local area network 108 that permits the pet to watch prerecorded and/or real-time content such as a rabbit or duck in a nature video or real time exercise of the owner in the wellness facility 100 so as to enhance the medical benefits for the pet obtained from the pet viewing the owner.

In an embodiment of the wellness center 100, the pet and the owner enter the wellness facility 100 together. When the pet and the owner are there for the benefit of exercising together, the owner may check in with an employee at the reception area 104. They may also present to the social networking area 105 that may be in communication with the local area network 108 such that sensed measurements from the biosensor may be recorded if desired. Thereafter, the owner and the pet may then proceed to an open or pet exercise station 128, 130 where the owner, who may be assisted by an employee at the wellness facility, may harness the pet for safety if necessary and start the pet exercising at the pet exercise station 128, 130. The owner then begins to exercise at a human exercise station 116, 118 that is near or next to the pet so as to ensure the pet is safe while exercising and to enjoy the health benefit that is obtained from the pet directly seeing the owner, where directly is understood as viewing the owner without any digital assistance such as on the electronic display 140 while the pet and owner are exercising.

In another example, the pet and owner enter the wellness facility 100 together in order to participate in a prescribed pet exercise plan that is part of prescribed wellness program for the pet as prescribed by a veterinarian. The owner may check in with a veterinary professional who may retrieve sensed biophysical parameters from at least one biosensor (not shown) carried on or embedded in, for example, the pet's collar, or carried on or embedded in the pet. Such retrieval may be, but is not limited to, RF communication where the veterinary assistant can obtain identity information, such as the pet's name and address and/or a unique pet identifier. By unique it is meant a number or string of characters or letters or numbers or combinations thereof that identify only that pet. In other examples, the biosensor may be configured for communication with the local area network 108. The veterinary professional may input the pet identity information into the computing device 106 to retrieve the pet's digital medical record from the secure on-site server 112 or the off-site secure server 114. The pet and the owner may also present to the social networking area 105.

Once the pet's digital medical record is retrieved and displayed to the veterinary professional, the veterinary professional may record in the pet's digital medical record any relevant medical information from the owner. Such medical information may include, for example, the pet's nutrition quality and quantity, its quantity and cycle of sleeping or its general comportment such as its activity level or perceived mobility issues, e.g. agility, limps, response to commands, etc. The veterinary professional may also retrieve stored or real time sensed biophysical parameters retrieved from at least one biosensor carried on or embedded in the pet, carried on the owner, or attached either physically or electronically to the pet exercise station 128, 130.

Thereafter, the veterinarian professional, may conduct a physical examination of the pet, and record the results in the pet's digital medical record. The type of physical examination may depend on whether the veterinary professional is a veterinarian or another trained professional such as a veterinary technician. Provided there are no medical findings that would prevent the pet from exercising, the veterinary professional will take the pet to the prescribed pet exercise station 128, 130. The pet may be furnished with a harness for safety and or for the sensing of biophysical parameters of the pet that can be viewed by the veterinary professional at the pet exercise station 128, 130 for example via either a mobile device or the interactive programmable controller 136, 138 with display at the pet exercise station 128, 130. Thus, remote monitoring of the sensed biophysical parameters may be available via the mobile device for example or where there is access to the internet via a personal computer.

The pet and owner are together while they exercise and the owner may or may not, as previously discussed be visible to the pet. This togetherness, where the pet and owner enter a facility together but may not be visible to one another during certain events is common in owner-pet veterinary facility visits where the owner and the pet may become physically separated as when, for example, the pet is under anesthesia during surgery prior to subsequent, post-recovery physical client-pet re-union.

During exercise and after the pet has completed its exercise as scheduled in the prescribed pet exercise plan, the veterinary professional may record any further relevant medical information in the pet's digital medical record. Pet exercise data obtained by at the least one biosensor may be automatically uploaded to the secure on-site server 112 or the off-site secure server 114. The owner and the pet may also present to the social networking area 105 after the exercise has been completed and either before or after they present to the veterinary professional.

The veterinary professional is able to retrieve the biosensor data and or digital medical record of the pet from the on site secure server 112 or the off site secure server 114. The digital medical record includes but is not limited to the results of the scheduled exercises of the prescribed pet exercise program carried out at the wellness facility 100. The exercise results together with any other biosensor diagnostics and/or physical exam findings may be used to modify the prescribed pet wellness plan including the prescribed pet exercise plan with the goal of regaining the pet's health, improving the pet's health, or maintaining the pet's health.

Accordingly, periodically or when medical concerns found at the wellness facility 100 by the veterinary professional are found either from direct pet examination or from biosensor data, and/or when the owner notes concerns outside the wellness facility 100, the pet may be further evaluated by the DVM for medical improvement.

The pet and owner may then return to the wellness facility 100 to simply exercise without supervision by a veterinary professional or to carry out a prescribed pet wellness program including a prescribed pet exercise plan under the supervision of a veterinary professional until the goals of the pet wellness program have been met.

The wellness facility 100 may include a pet kennel area 142, employee/veterinary professional locker room 144, and an owner locker room 146.

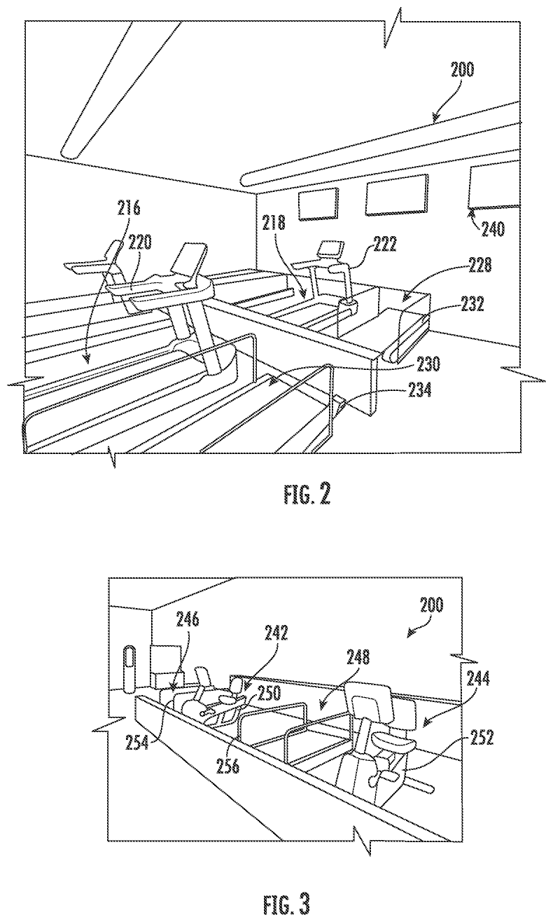

FIG. 2 illustrates an embodiment of a wellness center 200 that is similar to the wellness center 100. The human exercise stations 216, 218 are next to the pet exercise stations 228, 230, respectively. The human exercise stations 216, 218 each include a human exercise device 220, 222 that is a dry treadmill in the illustrated embodiment. The pet exercise stations 228, 230 each include a pet exercise device 232, 234 that is a dry pet treadmill in the illustrated embodiment. The pet exercise stations 228, 230 may each have an electronic display 240.

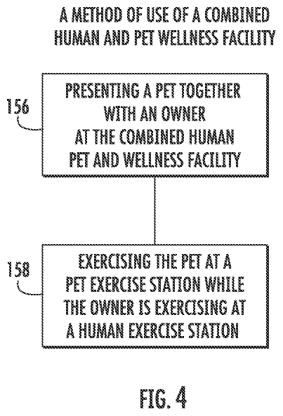

FIG. 3 illustrates another view of the wellness center 200. The human exercise stations 242, 244 are next the pet exercise stations 246, 248. The human exercise stations 242, 244 each include a human exercise device 250, 252 that is a recumbent bike in the illustrated embodiment. The pet exercise stations 246, 248 each include a pet exercise device 254, 256 that is a dry pet treadmill in the illustrated embodiment.

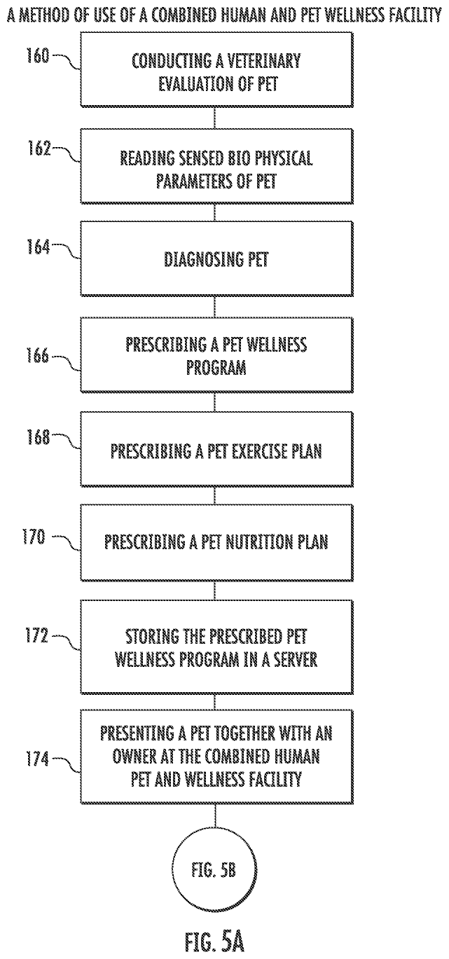

Turning now to FIG. 4 and with reference to FIG. 1, an example of steps of a method of use of a combined human and pet wellness center 100 (FIG. 1) of the invention are set forth. The method may include the step 156 of presenting a pet together with an owner of the pet at a combined human and pet wellness facility 100 (FIG. 1). The method may include the step 158 exercising the pet at the least one pet exercise station 128 (FIG. 1) while an owner of the pet is exercising at the at least one human exercise station 116 (FIG. 1). By exercising the pet it is meant that a human, for example the owner, or an employee must ensure the pet presents to the pet exercise station 116 to which it may be assigned and/or may need to safely start a pet exercise device 132 (FIG. 1) for the pet to exercise.

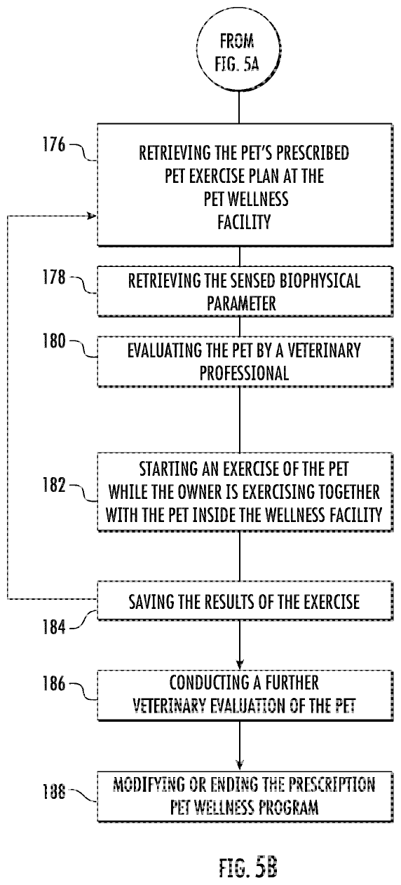

In another embodiment of a method of use of the combined human and pet wellness center 100 (FIG. 1) is set forth in FIG. 5A and continued in FIG. 5B. The method may include the step 160 of conducting a veterinary evaluation of the pet. The veterinary evaluation may be needed, for example, because of a trauma or sudden change in medical condition suffered by the pet, for example, a broken leg, dangerously elevated temperature or critical respiratory anomaly. Alternatively, the veterinary evaluation in conjunction with veterinary staff review of biosensor biophysical data may be a routine evaluation of the pet to find or prevent any possible medical conditions that would be detrimental to the pet's wellness, for example recent injury, blood irregularities, lymph node swelling, a heart murmur or abdominal bloating, that may lead to dramatic alteration in the quality of the pet's life.

The veterinary evaluation may include the pet owner's description of the pet's eating, sleeping, activity level, nutrition or observed conditions such as skin, weight changes, hair, respiratory, heart or mobility problems. The veterinary evaluation may include review of real-time and or historical and or continuously monitored biosensor data, predictive medical analytics based on historical pet diagnostics and biosensor data, ordering or evaluating additional diagnostic testing for example, complete blood count, serum biochemical analysis, urinalysis, fecal exam, intra-ocular pressure measurement, blood pressure measurement, electrocardiogram, radiographs, ultrasound, biopsies with histopathology examination, operative findings, MRI's, and CT scans by way of a few non-limiting examples.

The veterinary evaluation may include the step 162 of reading the pet's real time or stored sensed biophysical parameter obtained from one or more biosensors that may be carried by the pet. Alternatively, the veterinarian may place a biosensor on or embed the biosensor in the pet to permit the reading of sensed biophysical parameter for use after the veterinary evaluation in determining whether there has been medical improvement in the pet.

The method may include the step 164 of diagnosing the pet. The diagnosis may be based on the pet's symptoms, diagnostic results, and sensed biophysical parameters. The method may further include the step 166 of prescribing a pet wellness program or modification of an existing pet wellness program. The pet wellness program may include the step 168 of prescribing a pet exercise plan and the step 170 of prescribing a pet nutritional plan.

The prescribed pet exercise plan may be of prescribed exercises such as walks or runs. They may be of high intensity or low intensity or combinations thereof. They may have set periods of rest and may require aerobic or anaerobic exercise or combinations thereof which may also be accomplished pet exercise devices 132 (FIG. 1) such as on a dry pet treadmill. Such exercises of the prescribed pet exercise plan may also be low impact exercises such as swimming or walking on an underwater treadmill that may also be aerobic or anaerobic exercises and that can be carried out for example, on underwater pet treadmills or in pet swimming pools. Moreover, such prescribed exercises of the prescribed pet exercise plan may require monitoring and supervision by a trained veterinary professional such as the veterinarian, a veterinary technician, or veterinary assistant trained in carrying out, monitoring, and recording the results of the pet's exercise. The veterinary professionals may also obtain from the pet certain biophysical parameters before, during and after the pet's exercise or therapy.

The method may include the step 172 of storing both the prescribed pet wellness program and the data from biosensors in a digital medical record of the pet on the on-site secure server 112 (FIG. 1) or the off-site secure server 114 (FIG. 1) or both.

The method may include the step 174 of presenting the pet together with the owner at the combined human and pet wellness center 100 (FIG. 1) to carry out the prescribed pet exercise plan. The presenting includes presenting to a veterinary professional inside the wellness facility 100 (FIG. 1) who may carry out the step 176 of retrieving the pet's prescribed exercise plan of the prescribed pet wellness program from the pet's digital record on the on site server 112 (FIG. 1) or secure off site server 114 (FIG. 1).

In another step 178 of the method, the veterinary professional may retrieve stored or real time sensed biophysical parameters of the pet. The sensed biophysical parameters may be retrieved from the biosensor carried on or embedded in the pet or integrated in the pet exercise station 128, 130 (FIG. 1) for real time viewing at the pet's presentation in the wellness facility 100 (FIG. 1) or throughout the pet's exercising or as stored via various information storage means such as on the biosensor or mobile device or secure on site server 112 (FIG. 1) or secure off site server 114 (FIG. 1) or stored on some combination of these information storage means. The sensed biophysical parameters may be transmitted from storage to the pet's digital medical record on the secure on-site server 112 (FIG. 1) or secure off-site server 114 (FIG. 1).

The method may include the step 180 of evaluating and/or analyzing the pet and the pet's biophysical parameters by a veterinary professional inside the wellness facility 100 (FIG. 1). The evaluation, may include retrieving the pet's prescribed exercise plan, reading the sensed biophysical parameters and conducting a physical exam. The physical exam may include the pet's weight and or respiration, to name a few non-limiting examples of possible findings.

Thereafter, the veterinary professional may carry out a further step 182 of the method of starting an exercise for the pet as ordered in the prescribed pet exercise plan while the owner is also invited to exercise together with the pet in the wellness facility 100 (FIG. 1). The prescribed pet exercise plan may require use of any number of different pet exercise stations 128, 130 (FIG. 1). For example, the pet exercise station 128,130 (FIG. 1) may include a pet exercise device 132 (FIG. 1) such as a dry pet treadmill, an underwater pet treadmill, or endless pool. Alternatively, the pet exercise station 128,130 (FIG. 1) may be an open area for pet agility exercise that may have been prescribed and that can be carried out in an open area within the wellness facility 100 (FIG. 1).

The pet is then brought to the pet exercise station 128, 130 (FIG. 1) to start the prescribed pet exercise. In an example, the pet exercise station 128, 130 (FIG. 1) includes a pet exercise device 132, 134 (FIG. 1). The pet exercise device 132, 134 (FIG. 1) may include an interactive programmable controller 136, 138 (FIG. 1) with an interactive electronic display and may be a smart device that is able to communicate via Wi-Fi with a secure server 112, 114 (FIG. 1) to retrieve the pet's digital medical record and prescribed pet exercise plan. At the pet exercise device 132, 134 (FIG. 1) the veterinary professional may be able to retrieve the pet's digital medical record and the prescribed exercise plan and then set the machine parameters as indicated in the pet's prescribed exercise plan. For example, the pet may start the prescribed exercise plan in the endless pool or underwater treadmill or dry pet treadmill. The veterinary professional may harness the pet for safety in the endless pool or underwater treadmill or dry pet treadmill apparatus. The harness may or may not have biosensors that communicate real time sensed bio parameters of the pet. The pet exercise station 128, 130 (FIG. 1) may be an open area where the pet may be harnessed or leashed for safety and to facilitate the pet exercise plan and or collection of sensed biophysical parameters of the pet.

The step 182 of starting an exercise of the pet may include setting pet exercise equipment control of the pet exercise device 132, 134 (FIG. 1) according to the prescribed pet exercise plan. For example, with an endless pool, pool water propulsion acceleration, speed or deceleration may be set to control pet swimming resistance. So too, a motor speed or treadmill inclination may be set on the dry pet treadmill and a duration of time and or frequency of acceleration, speed and deceleration cycles for the exercise may be set. The physical settings of components of the pet exercise devices 132, 134 (FIG. 1) may be done manually by the veterinary professional or may be done automatically by commands received by the pet exercise device 132,134 (FIG. 1) or by commands received via, for example, by the computing device 106 (FIG. 1), the secure on site server 112 (FIG. 1), or the secure off site server 114 (FIG. 1).

Real time sensed biophysical parameters of the pet while it is exercising may be retrieved for example by a biosensor embedded in the pet or on the pet's collar or from a biosensor on the harness that may be physically connected to the pet exercise device or wirelessly connected to the pet exercise device or local area network. The veterinary professional may periodically monitor the pet and the real time sensed biophysical parameters of the pet during the prescribed pet exercise plan to ensure pet safety and to carry out the prescribed pet exercise plan. The veterinary professional may save the sensed results in the pet's digital medical record.

While the pet is exercising, the owner may be together with the pet in the same wellness facility 100 (FIG. 1) exercising but the owner may not be visible to the pet. The pet owner may be visible to the pet via an electronic display 140 (FIG. 1) for example a TV that displays to the pet the owner in real time exercising in another part of the wellness facility 100 (FIG. 1) at a human exercise station 116 (FIG. 1), but as discussed earlier, such an electronic display does not have to be present for the pet and owner to experience the benefit of togetherness as entering the wellness facility together, may suffice.

The method may include the step 184 of saving the results of the prescribed pet exercise in the digital medical record of the pet. For example, after the pet has completed its prescribed exercise of the prescribed exercise plan, the veterinary professional may perform another physical examination and or record any further relevant medical information, for example, the pet's weight, or post exercise sensed biophysical parameters. in the pet's digital medical record for review by a veterinarian. Provided there are no medical reasons for the pet to present to the veterinarian again, steps from 176 and following to step 184 may be repeated to complete the prescribed pet exercise plan at the wellness facility 100 (FIG. 1) with the owner.

The method may also include the step 186 of conducting a further veterinary evaluation of the pet in which the step 188 of modifying or ending the prescription pet wellness may take place. In an example, the veterinary evaluation my take place as part of a periodically scheduled set of veterinary evaluations for assessing whether the prescribed pet wellness plan is enabling the pet to meet expected medical health improvement outcomes. In another example, the veterinary evaluation my take place if medical concerns are raised at the wellness facility 100 by the veterinary professional, or where the owner finds concerns outside the wellness facility 100 (FIG. 1). Thus, steps 160 and following may be repeated such that the prescribed pet wellness program may remain the same or be modified depending upon whether there has been medical improvement or until the goals of the pet wellness program have been met. Where the pet has achieved the expected medical results the pet wellness program may be adjusted such that steps 160 and following are used to meet long-term optimal wellness medical objectives as the pet ages.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A combined human and pet wellness facility comprising:
at least one human exercise station inside the combined human and pet wellness facility;
at least one pet exercise station together with the human exercise station;
wherein the at least one human exercise station and the at least one pet exercise station are configured for simultaneous use.

2. The combined human and pet wellness facility of claim 1, wherein the at least one pet exercise station is near the human exercise station.

3. The combined human and pet wellness facility of claim 1, wherein the at least one pet exercise station is next to the human exercise station.

4. The combined human and pet wellness facility of claim 1, wherein the at least one pet exercise station includes a pet exercise device or open space.

5. The combined human and pet wellness facility of claim 4, wherein the pet exercise device is one of a dry pet treadmill, an underwater pet treadmill, and an endless pool.

6. The combined human and pet wellness facility of claim 4, wherein the human exercise station includes a human exercise device or an open space, or a designed space.

7. The combined human and pet wellness facility of claim 6, wherein the human exercise device is one of a dry treadmill, a recumbent bike, a speed bike, an elliptical machine, a weight machine, a resistance machine, a stair stepper, and a rowing machine.

8. The combined human and pet wellness facility of claim 1, further comprising a facility network comprising at least one computing device, the at least one pet exercise station, and a server.

9. The combined human and pet wellness facility of claim 8, wherein the facility network is a wireless network in communication with a wide area network.

10. The combined human and pet wellness facility of claim 8, wherein the facility network includes a pet biosensor.

11. The combined human and pet wellness facility of claim 10, wherein the pet biosensor senses and communicates to the server a biophysical parameter of the pet carrying the pet biosensor.

12. The combined human and pet wellness facility of claim 8, wherein the facility network comprises a social networking area in communication with the facility network.

13. A method for combined human and pet wellness, the method comprising the steps of:
presenting a pet together with an owner of the pet at a combined human and pet wellness facility comprising:
at least one human exercise station inside the combined human and pet wellness facility;
at least one pet exercise station together with the human exercise station;
exercising the pet at the least one pet exercise station while an owner of the pet is exercising at the at least one human exercise station.

14. The method of claim 13, further comprising the step of performing a veterinary medical exam of the pet to determine a prescribed pet wellness program that includes at least one of a prescribed pet exercise plan and a pet nutritional plan.

15. The method of claim 14, further comprising the step of providing a pet biosensor carried by the pet to sense at least one biophysical parameter of the pet.

16. The method of claim 14, wherein the step of exercising the pet at the at least one pet exercise station includes the step of exercising the pet at the at least one pet exercise station according to the prescribed pet exercise plan.

17. The method of claim 15, further comprising the step of storing the prescribed pet wellness program in a digital pet medical record stored in a server that is part of a network, the network including at least one computing device in the combined human and pet wellness facility, and the at least one pet exercise station.

18. The method of claim 17, further comprising the step of retrieving the prescribed pet exercise plan from the server by a veterinary professional when the pet arrives at the combined human and pet wellness facility.

19. The method of claim 18, further comprising the step of reading in real time the at least one sensed biophysical parameter of the pet by the veterinarian professional.

20. The method of claim 19, further comprising the step of recording a result of a pet's exercise according to the prescribed pet exercise plan in the pet's digital medical record.

21. The method of claim 20, further comprising the step of a veterinarian comparing the result of the pet's measured combined human-pet wellness performance with the prescribed pet wellness program medical objectives.
